(19) United States
(12) Patent Application Publication
(10) Pub. No.: US 2026/0126183 A1
(43) Pub. Date: May 7, 2026

(54) BAKING COOKING APPARATUS

(71) Applicant: NINGBO FOTILE KITCHEN WARE CO.,LTD., Ningbo (CN)

(72) Inventors: Kejie ZHU, Ningbo (CN); Zhejun WEI, Ningbo (CN); Fan CAI, Ningbo (CN); Ting YU, Ningbo (CN); Anlin CHEN, Ningbo (CN); Wentao NING, Ningbo (CN); Chunyang ZUO, Ningbo (CN); Lange MIAO, Ningbo (CN); Jingbo RU, Ningbo (CN)

(21) Appl. No.: 19/437,337

(22) Filed: Dec. 31, 2025

Related U.S. Application Data
(63) Continuation of application No. PCT/CN2025/078405, filed on Feb. 21, 2025.

(30) Foreign Application Priority Data
Aug. 30, 2024 (CN) 202422117273.6

(51) Int. Cl. F24C 15/20; F24C 15/32

(52) U.S. Cl. CPC F24C 15/2007; F24C 15/322

(57) ABSTRACT

The present application relates to a baking cooking apparatus. The baking cooking apparatus includes an cooking-chamber assembly, a hot fan baffle, a back plate and a purification assembly. The cooking-chamber assembly and the back plate are respectively located on two sides of the hot fan baffle. A cooking chamber is formed between one side of the hot fan baffle and the cooking-chamber assembly. A hot air chamber is formed between the other side of the hot fan baffle and the back plate. The hot fan baffle is provided with air outlet holes and a return air holes to communicate the cooking chamber with the hot air chamber. At least part of the purification assembly is arranged in the hot air chamber.

### CROSS-REFERENCE TO RELATED APPLICATIONS

The present disclosure is a continuation of international patent application No. PCT/CN2025/078405, filed on Feb. 21, 2025, which itself claims priority to Chinese patent application No. 202422117273.6, filed on Aug. 30, 2024, and titled “BAKING COOKING APPARATUS”. The contents of the above identified applications are hereby incorporated herein in their entireties by reference.

### TECHNICAL FIELD

The present disclosure relates to the field of cookware, and in particular, to a baking cooking apparatus.

### BACKGROUND

An oven and a steam oven are both baking cooking apparatuses, and such apparatuses generate a circulating hot air flow through a hot air assembly to heat and cure food materials. The hot air flow first flows out of the hot air assembly, then passes through the hot fan baffle to enter a cooking chamber, then the hot air flow turns off and flows back to the hot fan baffle so as to pass through the hot fan baffle again. When the hot air flow returns to the hot air assembly, a circulation process ends, and after repeating the above circulation process several times, the hot air flow is discharged from the baking cooking apparatus.

In a process of developing the baking cooking apparatus, it is generally desirable that the hot air flow can perform multiple rounds of circulation, which can improve a utilization rate of the heat carried by the hot air flow and avoid the increase of power consumption caused by the frequent start of heating of the hot air assembly, but the hot air flow absorbs components with odor in the food material during the circulation process, the concentration of the odor components in the hot air flow increases as the number of cycles increases, and when the hot air flow is discharged from the baking cooking apparatus, it will bring strong discomfort to the user.

### SUMMARY

In view of this, the present disclosure provides a baking cooking apparatus capable of reducing a concentration of odor components in the hot air flow and improving a pungent sensation caused by a discharge of a hot air flow.

The present disclosure provides a baking cooking apparatus including a cooking-chamber assembly, a heat fan baffle, a back plate and a purification assembly. The cooking-chamber assembly and the back plate are respectively located on two sides of the heat fan baffle. A cooking chamber is formed between one side of the heat fan baffle and the cooking-chamber assembly. A hot air chamber is formed between the other side and the back plate. The heat fan baffle is provided with air outlet holes and air return holes to communicate the cooking chamber with the hot air chamber, and at least part of the purification assembly is arranged in the hot air chamber.

In some embodiments, the baking cooking apparatus further includes a hot air assembly. The hot air assembly includes a fan disposed in the hot air chamber. The purification assembly includes an odor removal member disposed in the hot air chamber. The odor removal member is disposed on an outer peripheral side of the fan.

In some embodiments, the hot air assembly further includes a heating tube disposed in the hot air chamber. The heating tube is located on an outer peripheral side of the fan. The odor removal member is located on a side of the heating tube away from the fan.

In some embodiments, the heating pipe includes a closed-loop pipe section surrounding the fan, and the odor removal member is a closed-loop structure surrounding the closed-loop pipe section.

In some embodiments, two ends of the odor removal member respectively abut against the heat fan baffle and the back plate.

In some embodiments, the closed-loop pipe section and the odor removal member are both annular structures, and the closed-loop pipe section, the odor removal member and the fan are coaxially arranged.

In some embodiments, the odor removal member is provided with a ventilation hole, and the ventilation hole passes through a side of the odor removal member adjacent to the fan and passes through a side of the odor removal member relatively away from the fan.

In some embodiments, the baking cooking apparatus further includes a fan disposed in the hot air chamber. The hot fan baffle includes a return portion provided with a return air hole. The return air portion faces an air inlet end of the fan. The purification assembly includes a odor removal member located in the hot air chamber. The odor removal member is disposed between the return air portion and the air inlet end of the fan.

In some embodiments, the odor removal member is provided with a ventilation hole, the ventilation hole passes through a side of the odor removal member adjacent to the air return portion, and passes through a side of the odor removal member adjacent to the air inlet end of the fan.

In some embodiments, the baking cooking apparatus further includes a fan disposed in the hot air chamber. The purification assembly includes an odor removal member located in the hot air chamber. A rotation axis of the fan passes through the heat fan baffle. A minimum distance between the air outlet holes and the rotation axis of the fan is not less than a maximum distance between the odor removal member and the rotation axis of the fan.

In some embodiments, the hot air fan baffle includes a baffle portion and a flange portion. The baffle portion is provided with at least part of air outlet holes; and/or the flange portion is bent and connected to an outer peripheral edge of the baffle portion and protrudes from a side of the baffle portion facing the back plate, the air outlet holes include side air outlet holes provided in the flange portion, and an opening of each of the side air outlet holes face an inner wall surface of the cooking-chamber assembly.

In some implementations, the cooking-chamber assembly includes a first side plate, a top plate, a second side plate, and a bottom plate that are sequentially disposed in a circumferential direction of the rotation axis of the fan. The flange portion is a closed-loop structure surrounding the baffle portion, and includes a first side convex edge, a top convex edge, a second side convex edge, and a bottom convex edge that respectively face the first side plate, the top plate, the second side plate, and the bottom plate. The side air outlet holes are provided in any one or more of the first side convex edge, the top convex edge, the second side convex edge, and the bottom convex edge.

In some embodiments, the flange portion further includes a first inclined convex edge, a second inclined convex edge, a third inclined convex edge and a fourth inclined convex edge. The first inclined convex edge is connected to the first side convex edge and the top convex edge, and faces an included angle between the first side plate and the top plate; the second inclined convex edge is connected to the top convex edge and the second side convex edge, and faces an included angle between the top plate and the second side plate; the third inclined convex edge is connected to the second side convex edge and the bottom convex edge, and faces an included angle between the second side plate and the bottom plate; the fourth inclined convex edge is connected to the bottom convex edge and the first side convex edge, and faces an included angle between the bottom plate and the first side plate. None of the first inclined convex edge, the second inclined convex edge, the third inclined convex edge and the fourth inclined convex edge is provided with side air outlet holes.

Details of one or more embodiments of the present disclosure are presented in the attached drawings and descriptions below. And other features, purposes and advantages of The present disclosure will become apparent from the description, drawings and claims.

### BRIEF DESCRIPTION OF THE DRAWINGS

For a better description and illustration of embodiments and/or examples of those inventions disclosed herein, reference may be made to one or more attached drawings. Additional details or examples used to describe the drawings should not be considered as limiting the scope of any of the disclosed inventions, currently described embodiments and/or examples, and currently understood best modes of these inventions.

FIG. 1 is a front view of a baking cooking apparatus according to an embodiment of the present disclosure.

FIG. 2 is a sectional view of the baking cooking apparatus shown in FIG. 1 along a plane A-A.

FIG. 3 is a partially enlarged view of the baking cooking apparatus of FIG. 2.

FIG. 4 is a partial structural schematic diagram of a baking cooking apparatus according to an embodiment of the present disclosure.

FIG. 5 is a schematic structural diagram of a baking cooking apparatus after removing a heat fan baffle according to an embodiment of the present disclosure.

FIG. 6 is a schematic structural diagram of a heat fan baffle of a baking cooking apparatus according to an embodiment of the present disclosure under a first view.

FIG. 7 is a schematic structural diagram of a heat fan baffle of a baking cooking apparatus according to an embodiment of the present disclosure under a second view.

In the drawings: 10 represents a cooking-chamber assembly; 11 represents a first side plate; 12 represents a top plate; 13 represents a second side plate; 14 represents a bottom plate; 20 represents a hot air fan baffle; 201 represents a front side; 202 represents a rear side; 21 represents an air return portion; 211 represents an air return hole; 22 represents a baffle portion; 231 represents a first side convex edge; 232 represents a top convex edge; 233 represents a second side convex edge; 234 represents a bottom convex edge; 235 represents a first inclined convex edge; 236 represents a second inclined convex edge; 237 represents a third inclined convex edge; 238 represents a fourth inclined convex edge; 24 represents a side air outlet hole; 30 represents a back plate; 40 represents a purification assembly; 41 represents a odor removal member; 411 represents a ventilation hole; 50 represents a hot air assembly; 51 represents a fan; 52 represents a heating pipe; 61 represents a cooking chamber; and 62 represents a hot air chamber.

### DETAILED DESCRIPTION

The technical solutions of the present disclosure will be described clearly and completely with reference to embodiments. The embodiments as described are merely some rather than all of the embodiments of the present disclosure. All other embodiments obtained by one skilled in the art on the basis of the embodiments in the present disclosure without involving any inventive effort fall within the protection scope of the present disclosure.

Unless otherwise defined, all technical and scientific terms used herein have the same meaning as commonly understood by those skilled in the art to which the present disclosure belongs. The terms used herein in the specification of the present disclosure are only for the purpose of describing specific embodiments, and are not intended to limit the present disclosure. As used herein, the term “and/or” includes any and all combinations of one or more of the associated listed items.

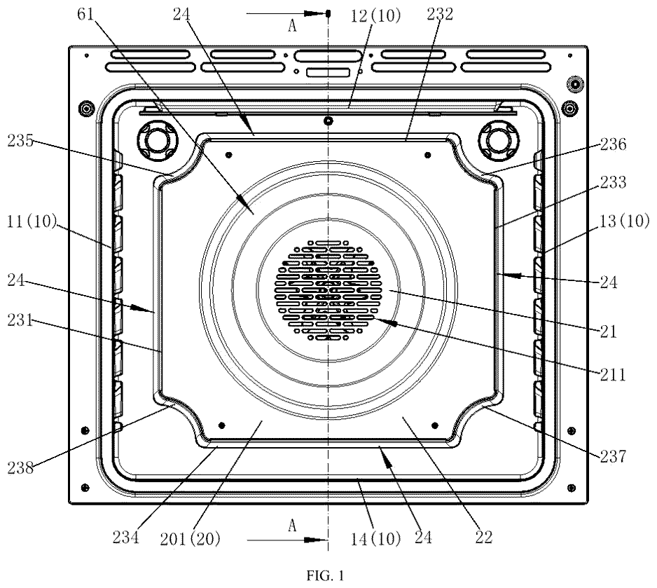

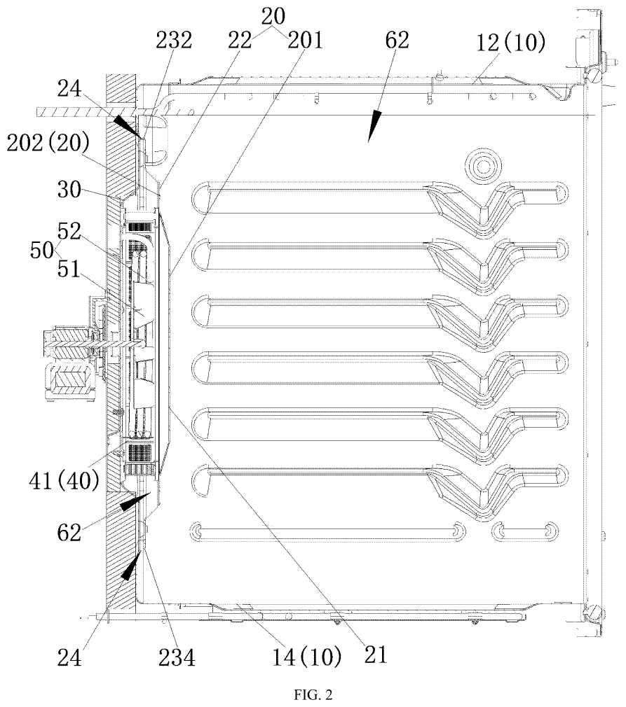

The present disclosure provides a baking cooking apparatus. The baking cooking apparatus may be specifically an oven, a steam oven, or the like. Referring to FIG. 1 to FIG. 2, the baking cooking apparatus of the present disclosure includes a cooking-chamber assembly 10, a hot fan baffle 20, a back plate 30 and a hot air assembly 50. The hot fan baffle 20 includes a front side 201 and a back side 202 arranged opposite to each other. The cooking-chamber assembly 10 and the back plate 30 are respectively located on the front side 201 and the back side 202 of the hot fan baffle 20. The front side 201 of the hot fan baffle 20 and the cooking-chamber assembly 10 are enclosed to form a cooking chamber 61. The back side 202 of the hot fan baffle 20 and the back plate 30 form a hot air chamber 62. The hot fan baffle 20 is provided with air outlet holes and air return holes 211. The air outlet holes and the air return holes 211 pass through the front side 201 and the back side 202 of the hot fan baffle 20, so that the cooking chamber 61 is communicated with the hot air chamber 62. The hot air assembly 50 is arranged in the hot air chamber 62. The hot air chamber 62 is used as a place for generating a hot air flow. The cooking chamber 61 is used for placing, heating and curing the food materials by hot air blow.

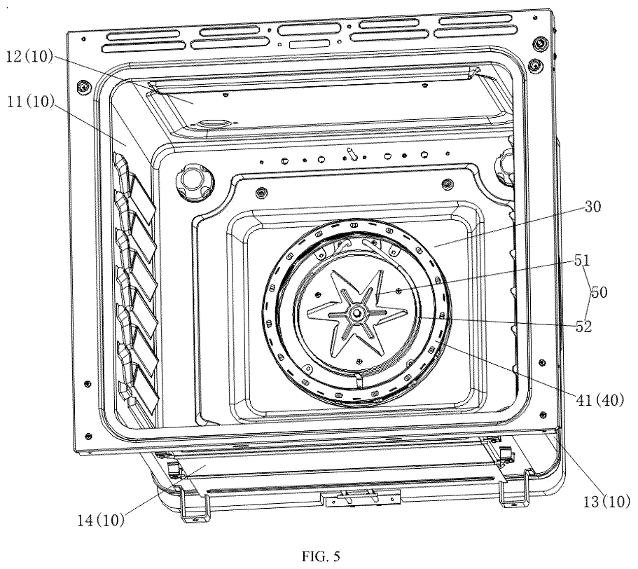

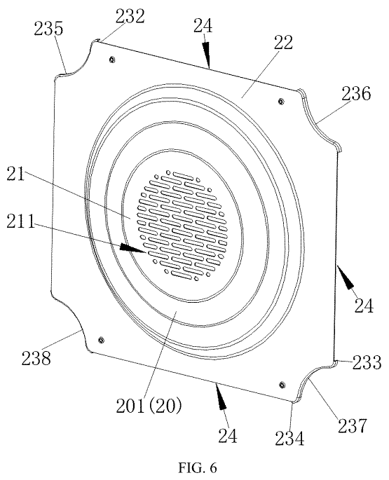

Specifically, the hot air assembly 50 includes a fan 51 rotatably disposed in the hot air chamber 62, and further includes a heating pipe 52 disposed in the hot air chamber 62. A rotation axis of the fan 51 passes through the hot air fan baffle 20. The cooking-chamber assembly 10 is a hollow prismatic structure having a chamber passage. An extension direction of the chamber passage is the same as an extension direction of the rotation axis of the fan 51. The hot air fan baffle 20 is located at one end of the chamber passage, so that an inner wall surface of the chamber passage and a front side 201 of the hot air fan baffle 20 are enclosed to form a cooking chamber 61, and the other end of the chamber passage forms a chamber opening to facilitate a user to take out or put food into the cooking chamber 61. Referring to FIG. 1, FIG. 5 to FIG. 6, the hot air fan baffle 20 includes a return air portion 21 and a baffle portion 22. The return air portion 21 is provided with a return air hole 211. The baffle portion 22 is connected to an outer peripheral edge of the return air portion 21. The return air portion 21 and the baffle portion 22 are parallel or coplanar. A rotation axis of the fan 51 vertically passes through the hot air fan baffle 20. The cooking-chamber assembly 10 includes a first side plate 11, a top plate 12, a second side plate 13 and a bottom plate 14 which are sequentially arranged along a circumferential direction of the rotation axis of the fan 51. The inner wall surface of the chamber passage includes a side of the first side plate 11 facing the second side plate 13, a side of the top plate 12 facing the bottom plate 14, a side of the second side plate 13 facing the first side plate 11 and a side of the bottom plate 14 facing the top plate 12.

When the baking cooking apparatus is used to bake the food, the hot air assembly 50 is first started to operate, the fan 51 rotates and disturbs the air in the hot air chamber 62 while the heating pipe 52 heats the air, thereby forming a hot air flow, the hot air flows through the air outlet holes and passes through the hot fan baffle 20 and then enters the cooking chamber 61, the hot air flow flows a certain distance in the cooking chamber 61 and then turns around and flows back to the hot fan baffle 20, the backflow hot air flow passes through the hot fan baffle 20 from the return air holes 211 as a backflow air flow and then enters the hot air chamber 62, and then the backflow air flow becomes a hot air flow again under the disturbance of the fan 51. The hot air flow repeats the above process to perform multiple rounds of circulation between the hot air chamber 62 and the cooking chamber 61 to heat the food material multiple times. Generally, the return air flow still has more heat, which means that in most cases, after entering the hot air chamber 62, the return air flow only needs to be disturbed again by the fan 51 to become the hot air flow again without being heated again, and only after the hot air flow circulates multiple times and the return air flow returning to the hot air chamber 62 drops below a certain temperature, this part of the return air flow needs to be heated again to become the hot air flow.

Therefore, in most cases, the operating condition of the hot air assembly 50 is as follows: in a complete cooking process of food materials, the fan 51 continuously rotates to provide power for the circulating flow of the hot air flow, the heating pipe 52 is intermittently started to operate, the heating pipe 52 stops operating after heating the air in the hot air chamber 62 once, the hot air flow circulates between the hot air chamber 62 and the cooking chamber 61 multiple times during the stopping operation of the heating pipe 52 until the temperature of the air in the hot air chamber 62 and the temperature of the backflow air flow entering the hot air chamber 62 drop below a certain temperature, and the heating pipe 52 operates again. In this way, not only the heat of the hot air flow is fully and efficiently used, but also the power consumption of the heating pipe 52 is reduced, the heating pipe 52 does not need to run continuously for a long time, and the fan 51 can be prevented from being broiled for a long time. After the food material is cooked, the remaining hot air in the cooking chamber 61 and the hot air chamber 62 will be discharged from the baking cooking apparatus.

Since the amount of the odor component in the food material diffused to the hot air flow will increase with the increase of the number of cycles of the hot air flow in the baking cooking apparatus, resulting in unpleasant smell of the hot air flow, the baking cooking apparatus of the present disclosure further includes a purification assembly 40. At least part of the purification assembly 40 is disposed in the hot air chamber 62. In this way, the backflow air flow entering the hot air chamber 62 and the air accumulated in the hot air chamber 62 can be filtered out of the odor component by the purification assembly 40, so that the concentration of the odor component of the newly generated hot air airflow in the hot air chamber 62 is reduced, and finally the hot air airflow is purified by the purification assembly 40. Thereby, the hot air is not easy to bring a strong feeling of piercing to the user after being discharged from the baking cooking apparatus, thereby reducing the influence of the discharged hot air on the environment.

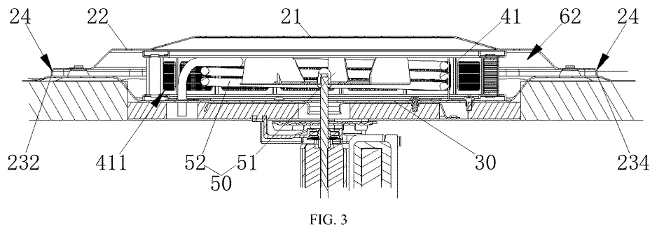

In some embodiments, the purification assembly 40 includes an odor removal member 41 located in the hot air chamber 62. Referring to FIG. 2 to FIG. 3, the odor removal member 41 is disposed on an outer peripheral side of the fan 51. The fan 51 includes a main body portion and fan blade portions connected to the main body portion. The main body portion is arranged opposite to the air return portion 21. The hot air assembly 50 further includes a driving member connected to the main body portion of the fan 51. The driving member can drive the fan 51 to rotate around a preset rotation center. The preset rotation center is used as a rotation axis of the fan 51. An outer peripheral side of the fan 51 includes tail ends of the fan blade portions away from the preset rotation center. When the fan 51 rotates, air is sucked so that the air is close to the main body portion along an extension direction of the preset rotation center, then the sucked air is pushed by the fan blade portions to be accelerated, and finally the air is thrown out of the tail ends of the fan 51 under a centrifugal action to form air flows, therefore, the outer peripheral side of the fan 51 formed by the tail ends of the fan blade portions is the air outlet portion of the fan 51, the air flows to the odor removal member 41 and is filtered by the odor removal member 41 after leaving the fan 51, and then the air flows are blown to the cooking chamber 61 as hot air flows.

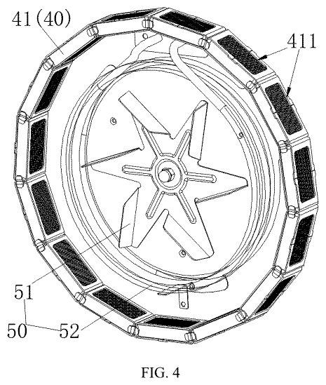

Specifically, referring to FIGS. 3 and 4, the heating pipe 52 is located on an outer peripheral side of the fan 51, and the odor removal member 41 is located on a side of the heating pipe 52 away from the fan 51. In this way, after the airflow is thrown out of the fan 51, the airflow first flows through the heating pipe 52 and is heated up by the heating pipe 52 to become a hot air airflow, and then the hot air airflow flows through the odor removal member 41 and is filtered out of the odor component by the odor removal member 41. That is, the odor removal member 41 purifies the airflow carrying heat, and the higher temperature can improve the efficiency of the odor removal member 41 in filtering and removing odor components. In some embodiments, the odor removal member 41 can chemically react with the odor component, and the hot air flow flowing through the odor removal member 41 can improve the chemical reaction rate between the odor removal member 41 and the odor component and catalyze the reaction. In other embodiments, the odor removal member 41 can physically adsorb and trap the odor component, and the temperature of the hot air flow can improve the activity of the odor removal member 41, thereby improving the capacity of the odor removal member 41 to trap and adsorb the odor component.

Optionally, referring to FIG. 4, the heating pipe 52 includes a closed-loop pipe section surrounding the fan 51 along the circumferential direction of the rotation axis of the fan 51. The odor removal member 41 is of a closed-loop structure, and the odor removal member 41 surrounds an outer peripheral side of the closed-loop pipe section along the circumferential direction of the rotation axis of the fan 51. That is, the odor removal member 41 itself has a hollow area, and the fan 51 and the closed-loop pipe section are both accommodated in the hollow area of the odor removal member 41. Optionally, the closed-loop pipe section and the odor removal member 41 are both of a circular ring structure, the closed-loop pipe section, the odor removal member 41 and the fan 51 are coaxially arranged, and the rotation axis of the fan 51 coincides with the axis of the closed-loop pipe section and also coincides with the axis of the odor removal member 41. In this way, the air thrown from each radial direction of the fan 51 can be heated by the heating pipe 52, and the air thrown from each radial direction of the fan 51 can be filtered by the odor removal member 41 to remove odor components, thereby improving purification effect and preventing the partial hot air flow from missing the odor removal member 41.

Optionally, referring to FIG. 3 to FIG. 4, two ends of the odor removal member 41 respectively abut against the rear side 202 of the fan baffle 20 and a side of the back plate 30 facing the fan baffle 20, so that one end of the hollow area of the odor removal member 41 is covered by the fan baffle 20, and the other end of the hollow area of the odor removal member 41 is covered by the back plate 30. Correspondingly, the odor removal member 41 is provided with a ventilation hole 411, and the ventilation hole 411 passes through one side of the odor removal member 41 adjacent to the fan 51, and also passes through the other side of the odor removal member 41 relatively away from the fan 51.

In this way, the odor removal member 41, the heat fan baffle 20 and the back plate 30 are together enclosed to form a closed space area. The closed space area is in communication with the cooking chamber 61 only through the air return holes 211, and the closed space area is in communication with the hot air chamber 62 located outside the odor removal member 41 only through the ventilation hole 411, which means that the backflow airflow entering the closed space area and the air accumulated in the closed space area can only be diffused to the hot air chamber 62 area outside the odor removal member 41 through the ventilation hole 411, ensuring that all the hot air airflow thrown out of the fan 51 can flow through the odor removal member 41 so that the odor removal member 41 can fully remove odor components, and significantly improving the odor elimination and purification effect.

As shown in FIG. 4 to FIG. 5, the ventilation holes 411 may specifically be meshes extending along the radial direction of the odor removal member 41. The meshes are uniformly distributed along the circumferential direction of the odor removal member 41. One end of each ventilation hole 411 adjacent to the rotation axis of the fan 51 passes through the inner peripheral side of the odor removal member 41. The inner peripheral side of the odor removal member 41 is the side of the odor removal member 41 adjacent to the fan 51 and the heating pipe 52, the other end of each ventilation hole 411 away from the rotation axis of the fan 51 passes through the outer peripheral side of the odor removal member 41, and the outer peripheral side of the odor removal member 41 is the other side of the odor removal member 41 away from the fan 51 and the heating pipe 52. In this way, the number of the ventilation holes 411 is large and the ventilation holes 411 are densely distributed, and the inner wall surface of the ventilation holes 411 serves as the main surface of the odor removal member 41 for filtering and removing odor components, which significantly increases the contact area between the odor removal member 41 and the hot air flow.

Referring to FIG. 1 to FIG. 3 and FIG. 6 to FIG. 7, in some embodiments, a part of the hot air fan baffle 20 protrudes relative to the back plate 30 along the rotation axis of the fan 51 and extends into the chamber passage, so that at least the baffle portion 22 is located in the chamber passage, the hot air fan baffle 20 further includes a flange portion. The flange portion is bent and connected to an outer peripheral edge of the baffle portion 22 and protrudes from a side of the baffle portion 22 facing the back plate 30, an end portion of the flange portion away from the outer peripheral edge of the baffle portion 22 is connected to the back plate 30. The flange portion is spaced apart from the inner wall surface of the chamber passage. The air outlet holes includes side air outlet holes 24 provided in the flange portion, and an opening of each of the side air outlet holes 24 faces the inner wall surface of the chamber passage. Optionally, the flange portion is a closed-loop structure extending along the outer peripheral edge of the baffle portion 22, the flange portion surrounds the baffle portion 22, and surrounds the hot air assembly 50 along the circumferential direction of the rotation axis of the fan 51, and the outer peripheral side of the odor removal member 41 faces the inner peripheral wall of the flange portion.

Specifically, as shown in FIG. 1, FIG. 5 to FIG. 7, the outer periphery of the baffle portion 22 is approximately octagonal, and includes a first side edge, a first oblique edge, a top edge, a second oblique edge, a second side edge, a third oblique edge, a bottom edge and a fourth oblique edge sequentially arranged along the circumferential direction of the rotation axis of the fan 51. The flange portion includes a first side convex edge 231 bent and connected to the first side edge, a first inclined convex edge 235 bent and connected to the first oblique edge, a top convex edge 232 bent and connected to the top edge, a second inclined convex edge 236 bent and connected to the second oblique edge, a second side convex edge 233 bent and connected to the second side edge, a third inclined convex edge 237 bent and connected to the third oblique edge, a bottom convex edge 234 bent and connected to the bottom edge, and a fourth inclined convex edge 238 bent and connected to the fourth oblique edge. One side of the first side plate 11 facing the second side plate 13 is spaced apart from and faces the first side convex edge 231. One side of the top plate 12 facing the bottom plate 14 is spaced apart from and faces the top convex edge 232. One side of the second side plate 13 facing the first side plate 11 is spaced apart from and faces the second side convex edge 233. One side of the bottom plate 14 facing the top plate 12 is spaced apart from and faces the bottom convex edge 234. Two ends of the first inclined convex edge 235 are respectively connected to the first side convex edge 231 and the top convex edge 232. One side of the first inclined convex edge 235 away from the hot air assembly 50 faces the angle between the first side plate 11 and the top plate 12. Two ends of the second inclined convex edge 236 are respectively connected to the top convex edge 232 and the second side convex edge 233. One side of the second inclined convex edge 236 away from the hot air assembly 50 faces the angle between the top plate 12 and the second side plate 13. Two ends of the third inclined convex edge 237 are respectively connected to the second side convex edge 233 and the bottom convex edge 234. One side of the third inclined convex edge 237 away from the hot air assembly 50 faces the angle between the second side plate 13 and the bottom plate 14. Two ends of the fourth inclined convex edge 238 are respectively connected to the bottom convex edge 234 and the first side convex edge 231. One side of the fourth inclined convex edge 238 away from the hot air assembly 50 faces the angle between the bottom plate 14 and the first side plate 11.

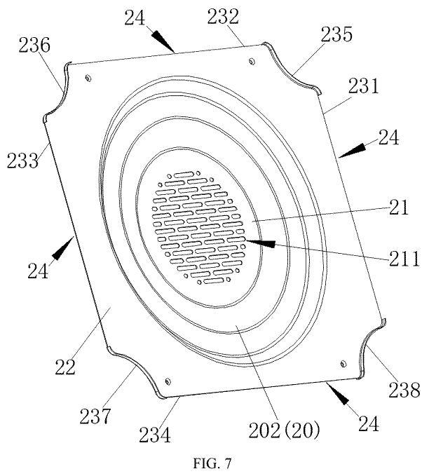

Optionally, as shown in FIG. 1, FIG. 6 to FIG. 7, the side air outlet holes 24 are formed in any one or more of the first side convex edge 231, the top convex edge 232, the second side convex edge 233 and the bottom convex edge 234. The first inclined convex edge 235, the second inclined convex edge 236, the third inclined convex edge 237 and the fourth inclined convex edge 238 are not provided with the side air outlet holes 24. This arrangement not only does not affect the hot air flow passing through the hot fan baffle 20 and blowing to the cooking chamber 61, but also can inhibit the hot air flow from flowing to the dead angle area of the inner wall surface of the inner container channel, thereby helping to increase the number of times the hot air flow circulates between the cooking chamber 61 and the hot air chamber 62. In particular, for example, in the case where the exhaust port is provided in the area of the top plate 12 close to the hot fan baffle 20 and the first side plate 11, inhibiting the flow of the hot air to the dead angle area of the inner wall surface of the inner container channel can inhibit the flow of the hot air to an exhaust port, and prevent the hot air from being prematurely discharged from the exhaust port to the baking cooking apparatus, thereby increasing the number of circulation times of the hot air.

Optionally, in some embodiments, the air outlet holes further includes a front air outlet hole provided in the baffle portion 22, and the hot air flow passing through the front air outlet hole can directly blow to the cooking chamber 61 and then directly flow to the end of the chamber passage away from the hot fan baffle 20. In contrast, due to the wall attachment effect of the fluid, the hot air flow passing through the side air outlet holes 24 mainly flows along an inner wall surface of the chamber passage, so the hot air flow passing through the front air outlet hole is responsible for directly baking the food material, while the hot air flow passing through the side air outlet holes 24 is more used to form a heat flow field occupying the cooking chamber 61, the heat flow field surrounds the food material, and the cooperation of the above two hot air flows ensures that the food material is fully heated and cured. The side air outlet holes 24 provided in the flange portion are more convenient for the hot air flow to pass through, and after the hot air flow is thrown out of the fan 51, there is a radial velocity vector of the radial flow along the rotation axis of the fan 51, and due to the radial velocity vector, most of the hot air flow directly blows towards the inner side of the flange portion towards the hot air assembly 50, and then directly passes through the side air outlet holes 24 until reaching the inner wall surface of the chamber passage. Of course, the front air outlet holes on the baffle portion 22 may also be eliminated.

Furthermore, whether the air outlet is a positive air outlet provided in the baffle portion 22 or a side air outlet holes 24 provided in the flange portion, or both the positive air outlet and the side air outlet holes 24, a minimum distance between the air outlet holes and the rotation axis of the fan 51 is not less than the maximum distance between the odor removal member 41 and the rotation axis of the fan 51. Referring to FIG. 2 to FIG. 3, the distance between the side air outlet holes 24 provided in the protruding portion and the rotation axis of the fan 51 is greater than the distance between the outer peripheral side of the odor removal member 41 and the rotation axis of the fan 51. If the front side 201 of the hot fan baffle 20 is observed in the direction of the line of sight parallel to the rotation axis of the fan 51, as shown in FIG. 1, projections of the air outlet holes on the parallel surface of the hot fan baffle 20 is projections of an air outlet openings, the projection of the odor removal member 41 on the parallel surface of the hot fan baffle 20 is the projection of the odor elimination position, the projections of the air return holes 211 on the parallel surface of the hot fan baffle 20 is the projections of the air return openings, and it is specified that the parallel surface of the hot fan baffle 20 is parallel to the hot fan baffle 20 and perpendicular to the rotation axis of the fan 51, then the projection of the odor elimination position is a closed-loop pattern, the projection of the air outlet opening is all located outside the projection of the odor elimination position, and the projection of the air return opening is all located inside the projection of the odor elimination position. In this way, all the backflow airflow entering the hot air chamber 62 through the air return holes 211 passes through the odor removal member 41 and then reaches the outer peripheral side of the odor removal member 41, and the hot air airflow blown from the air outlet holes to the cooking chamber 61 passes through the odor removal member 41.

The baking cooking apparatus of the present disclosure adopts the form of arranging the odor removal member 41 in the hot air chamber 62, and when the user removes the food material from the cooking chamber 61 or puts the food material into the cooking chamber 61, it will not be interfered by the odor removal member 41, and meanwhile, the situation that the odor removal member 41 is polluted by the food material is avoided, so that the odor removal member 41 can be kept clean for a longer time without frequent cleaning or replacement.

The technical features of the above-mentioned embodiments can be combined arbitrarily. In order to make the description concise, not all possible combinations of the technical features are described in the above embodiments. However, as long as there is no contradiction in the combination of these technical features, the combinations should be considered as in the scope of the present disclosure.

Those of ordinary skill in the art should realize that the above embodiments are only used to illustrate the present disclosure, and are not used to limit the present disclosure, as long as appropriate changes and variations made to the above embodiments within the essential spirit of the present disclosure fall within the scope of protection claimed by the present disclosure.

What is claimed is:

1. A baking cooking apparatus, comprising a cooking-chamber assembly, a heat fan baffle, a back plate and a purification assembly, wherein the cooking-chamber assembly and the back plate are respectively located on two sides of the heat fan baffle, a cooking chamber is formed between one side of the heat fan baffle and the cooking-chamber assembly, a hot air chamber is formed between the other side of the heat fan baffle and the back plate, the heat fan baffle is provided with air outlet holes and air return holes to communicate the cooking chamber with the hot air chamber, and at least part of the purification assembly is arranged in the hot air chamber.

2. The baking cooking apparatus of claim 1, further comprising a hot air assembly, wherein the hot air assembly comprises a fan disposed in the hot air chamber, the purification assembly comprises an odor removal member disposed in the hot air chamber, and the odor removal member is disposed on an outer peripheral side of the fan.

3. The baking cooking apparatus of claim 2, wherein the hot air assembly further comprises a heating tube disposed in the hot air chamber, the heating tube is located on the outer peripheral side of the fan, and the odor removal member is located on a side of the heating tube away from the fan.

4. The baking cooking apparatus of claim 3, wherein the heating pipe comprises a closed-loop pipe section surrounding the fan, and the odor removal member is a closed-loop structure surrounding the closed-loop pipe section.

5. The baking cooking apparatus of claim 4, wherein two ends of the odor removal member respectively abut against the heat fan baffle and the back plate; and/or
the closed-loop pipe section and the odor removal member are both annular structures, and the closed-loop pipe section, the odor removal member and the fan are coaxially arranged.

6. The baking cooking apparatus of claim 2, wherein the odor removal member is provided with a ventilation hole, and the ventilation hole passes through a side of the odor removal member adjacent to the fan, and passes through a side of the odor removal member away from the fan.

7. The baking cooking apparatus of claim 1, further comprising a fan disposed in the hot air chamber, wherein the hot air fan baffle comprises a return portion provided with the return air hole, the return portion faces an air inlet end of the fan, the purification assembly comprises an odor removal member disposed in the hot air chamber, and the odor removal member is disposed between the return portion and the air inlet end of the fan.

8. The baking cooking apparatus of claim 7, wherein the odor removal member is provided with a ventilation hole, the ventilation hole passes through a side of the odor removal member adjacent to the air return portion, and passes through a side of the odor removal member adjacent to the air inlet end of the fan.

9. The baking cooking apparatus of claim 1, further comprising a fan disposed in the hot air chamber, wherein the purification assembly comprises an odor removal member located in the hot air chamber, a rotation axis of the fan passes through the heat fan baffle, and a minimum distance between the air outlet holes and the rotation axis of the fan is not less than a maximum distance between the odor removal member and the rotation axis of the fan.

10. The baking cooking apparatus of claim 9, wherein the heat fan baffle comprises a baffle portion and a flange portion,
the baffle portion is provided with at least part of the air outlet holes; and/or
the flange portion is bent and connected to an outer peripheral edge of the baffle portion and protrudes from a side of the baffle portion facing the back plate, the air outlet holes comprises side air outlet holes provided in the flange portion, and an opening of each of the side air outlet holes faces an inner wall surface of the cooking-chamber assembly.

11. The baking cooking apparatus of claim 10, wherein the cooking-chamber assembly comprises a first side plate, a top plate, a second side plate, and a bottom plate that are sequentially disposed along a circumferential direction of the rotation axis of the fan, the flange portion is a closed-loop structure surrounding the baffle portion and comprises a first side convex edge, a top convex edge, a second side convex edge, and a bottom convex edge that respectively face the first side plate, the top plate, the second side plate, and the bottom plate, and the side air outlet holes are provided in any one or more of the first side convex edge, the top convex edge, the second side convex edge, and the bottom convex edge.

12. The baking cooking apparatus of claim 11, wherein the flange portion further comprises a first inclined convex edge, a second inclined convex edge, a third inclined convex edge and a fourth inclined convex edge;
the first inclined convex edge is connected to the first side convex edge and the top convex edge, and faces an included angle between the first side plate and the top plate;
the second inclined convex edge is connected to the top convex edge and the second side convex edge, and faces an included angle between the top plate and the second side plate;
the third inclined convex edge is connected to the second side convex edge and the bottom convex edge, and faces an included angle between the second side plate and the bottom plate;
the fourth inclined convex edge is connected to the bottom convex edge and the first side convex edge, and faces an included angle between the bottom plate and the first side plate; and
none of the first inclined convex edge, the second inclined convex edge, the third inclined convex edge, and the fourth inclined convex edge is provided with the side air outlet holes.
